(19) United States
(12) Patent Application Publication
(10) Pub. No.: US 2008/0152896 A1
(43) Pub. Date: Jun. 26, 2008

(54) PROCESS TO PREPARE CARBON NANOTUBE-REINFORCED FLUOROPOLYMER COATINGS

(76) Inventors: Carolyn Patricia Moorlag, Mississauga (CA); Nan-Xing Hu, Oakville (CA); Michael Steven Hawkins, Cambridge (CA); Guiqin Song, Milton (CA); Nicoleta Doinita Mihai, Oakville (CA)

Correspondence Address: PEPPER HAMILTON LLP, ONE MELLON CENTER, 50TH FLOOR, 500 GRANT STREET, PITTSBURGH, PA, 15219, US

(21) Appl. No.: 11/615,136

(22) Filed: Dec. 22, 2006

(51) Int. Cl. C08K 3/04; B32B 5/16; B05D 3/02

(52) U.S. Cl. 428/323; 524/496; 427/385.5

(57) ABSTRACT

A method to form a stable suspension includes dispersive mixing a semi-soft or molten fluoropolymer and a plurality of carbon fibrils by mechanical shear force to form a polymer composite and dispersing the composite into an effective solvent to form a stable suspension.

### CROSS-REFERENCE TO RELATED APPLICATIONS

Not applicable

### STATEMENT REGARDING FEDERALLY SPONSORED RESEARCH

Not applicable.

### NAMES OF PARTIES TO A JOINT RESEARCH AGREEMENT

Not applicable.

### SEQUENCE LISTING

Not applicable.

### BACKGROUND

1. Technical Field

The disclosed embodiments generally relate to the field of fusers or fixing members used in printing and copying operations. In particular, this disclosure relates to processes for applying a top layer coating onto a fuser roll. The top layer coating includes a carbon nanotube reinforced fluoropolymer composite with substantially uniform dispersion.

2. Description of the Related Art

In a typical electrostatographic printing apparatus, a light image of an original to be copied is recorded in the form of an electrostatic latent image upon a photosensitive member and the latent image is subsequently rendered visible by the application of electroscopic thermoplastic resin particles which are commonly referred to as toners The visible toner image is then in a loose powdered form and can be easily disturbed or destroyed. The toner image is usually fixed or fused upon a support which may be a photosensitive member itself or other support sheet such as plain paper.

The use of thermal energy for fixing toner images onto a support member is well known. In order to fuse electroscopic toner material onto a support surface permanently by heat, it is necessary to elevate the temperature of the toner material to a point at which the constituents of the toner material coalesce and become tacky. This heating causes the toner to flow to some extent into the fibers or pores of the support member. Thereafter, as the toner material cools, solidification of the toner material causes the toner material to be firmly bonded to the support.

Typically, thermoplastic resin particles are fused to the substrate by heating to a temperature of between about 90° C. to about 16° C. or higher depending upon the softening range of the particular resin used in the toner. It is not desirable, however, to raise the temperature of the substrate substantially higher than about 200° C. because of the tendency of the substrate to discolor at such elevated temperatures, particularly when the substrate is paper,

Several approaches to thermal fusing of electroscopic toner images have been described in the prior art. These methods include providing the application of heat and pressure substantially concurrently by various means: a roll pair maintained in pressure contact; a belt member in pressure contact with a roll; and the like. Heat may be applied by heating one or both of the rolls, plate members or belt members. The fusing of the toner particles takes place when the proper combination of heat, pressure and contact time is provided. The balancing of these parameters to bring about the fusing of the toner particles is well known in the art, and they can be adjusted to suit particular machines or process conditions.

During operation of a fusing system in which heat is applied to cause thermal fusing of the toner particles onto a support, both the toner image and the support are passed through a nip formed between the roll pair, or plate or belt members. The concurrent transfer of heat and the application of pressure in the nip affect the fusing of the toner image onto the support. It is important in the fusing process that no offset of the toner particles from the support to the fuser member take place during normal operations. Toner particles that offset onto the fuser member may subsequently transfer to other parts of the machine or onto the support in subsequent copying cycles, thus increasing the background or interfering with the material being copied there. The referred to “hot offset” occurs when the temperature of the toner is increased to a point where the toner particles liquefy and a splitting of the molten toner takes place during the fusing operation with a portion remaining on the fuser member. The hot offset temperature or degradation to the hot offset temperature is a measure of the release property of the fuse roll, and accordingly it is desired to provide a fusing surface, which has a low surfaced energy to provide the necessary release. To ensure and maintain good release properties of the fuser roll, it has become customary to apply release agents to the fuser roll during the fusing operation. Typically, these materials are applied as thin films of, for example, silicone oils to prevent toner offset.

Fuser and fixing rolls may be prepared by applying one or more layers to a suitable substrate. Cylindrical fuser and fixer rolls, for example, may be prepared by applying an elastomer or fluoroelastomer to an aluminum cylinder. The coated roll is heated to cure the elastomer. Such processing is disclosed, for example, in U.S. Pat. Nos. 5,501,881; 5,512,409; and 5,729,813; the disclosure of each of which is incorporated by reference herein in their entirety.

Fusing systems using fluoroelastomers as surfaces for fuser members are described in U.S. Pat. Nos. 4,264,181; 4,257,699; 4,272,179; and 5,061,965; the disclosure of each of which is incorporated by reference herein in their entirety.

U.S. Pat. No. 5,017,432, which is incorporated by reference herein in its entirety, describes a fusing surface layer obtained from a specific fluoroelastomer, poly(vinylidenefluoride-hexafluoropropylene-tetrafluoroethylene) where the vinylidenefluoride is present in an amount of less than 40 weight percent. This patent further discloses curing the fluoroelastomer with Viton® Curative No. 50 (VC-50) available from E. I. du Pont de Nemours, Inc., which is soluble in a solvent solution of the polymer at low base levels and is readily available at the reactive sites for cross-linking. This patent also discloses use of a metal oxide (such as cupric oxide) in addition to VC-50 for curing.

U.S. Pat. No. 7,127,205, which is incorporated in its entirety herein, provides a process for providing an elastomer surface on a fusing system member. Generally, the process includes forming a solvent solution/dispersion by mixing a fluoroelastomer dissolved in a solvent such as methyl ethyl ketone and methyl isobutyl ketone, a dehydrofluorinating agent such as a base, for example the basic metal oxides, MgO and/or Ca(OH)₂, and a nucleophilic curing agent such as VC-50 which incorporates an accelerator and a cross-linking agent, and coating the solvent solution,/dispersion onto the substrate. The surface is then stepwise heat cured. Prior to the stepwise heat curing, ball milling is usually performed, for from 2 to 24 hours.

Cross-linked fluoropolymers form elastomers, or fluoroelastomers, are chemically stable and exhibit good release properties. They are also relatively soft and display elastic properties. Fillers are often used as in polymer formulations as reinforcing particles to improve the polymer formulation hardness and wear resistance. Thermal conductivity of the fuser system is also important because the fuser or fixer must adequately conduct heat to soften the toner particles for fusing. In order to increase the thermal conductivity of the fuser or fixer member, thermally conductive particles, such as metal oxide particles have been used as fillers. In order to provide high thermal conductivity, the loading of the filler must be high. Loading of a filler that is too high, however, leads to coatings that are too hard, brittle, and more prone to wear. The addition of fillers of conventional metal oxides, such as aluminum, iron, copper, tin and zinc oxides are disclosed in U.S. Pat. Nos. 6,395,444; 6,159,588; 6,114,041; 6,090,491; 6,007,657; 5,998,033; 5,935,712; 5,679,463; and 5,729,813; each of which is incorporated by reference herein in their entirety. Metal oxide fillers, at loadings of up to about 60 wt %, provide thermal conductivities from about 0.2 to about 1.0 Wm⁻¹K¹⁻. However, the increased loading adversely affects the wear and lifetime of the fuser.

A more mechanically robust coating is required for new generation fusing systems in order to improve lifetime and diminish the occurrence of roll failure due to edge wear. Higher thermal conductivity of the top layer would improve heat retention at the surface during fusing, and electrical conductivity would dissipate any static charge buildup.

The disclosure contained herein describes attempts to address one or more of the problems described above.

### SUMMARY

An embodiment of a method for forming a stable suspension includes dispersive mixing of a semi-soft or molten fluoropolymer and a plurality of carbon fibrils by mechanical shear force to form a polymer composite. The composite is dispersed into an effective solvent to form a stable suspension.

In embodiments, the dispersive mixing may include extrusion. In embodiments the extrusion may include single screw extrusion or twin screw extrusion For some embodiments, the extrusion may include a rotor speed from about 10 revolutions per minute to about 200 rpm.

For embodiments herein, the fluoropolymer may include vinylidene fluoride with another monomer selected from the group consisting of vinylidene fluoride, hexafluoropropylene, tetrafluoroethylene, and mixtures thereof.

Exemplary embodiments may include carbon fibris of carbon nanotubes having a diameter less than about 100 nanometers. In further embodiments, the carbon nanotubes may be selected from the group consisting of single-walled carbon nanotubes, multi-walled carbon nanotubes, and mixtures thereof. In some embodiments, the polymer composite may contain carbon fibrils in an amount of from about 0.3 to about 30% by weight of the composite Alternatively, the polymer composite may contain carbon fibrils in an amount of from about 0.5 to about 10% by weight of the composite.

For exemplary embodiments, the effective solvent may be selected from the group consisting of acetone, methyl isobutyl ketone, methyl ethyl ketone, and mixtures thereof.

Still another embodiment includes a method, which includes dispersive mixing of nanoparticles and at least one polymer that includes a monomeric repeat unit of vinylidene fluoride by extrusion to form a composite, so that the nanoparticles are substantially non-agglomerated and substantially uniformly dispersed in the composite. The composite may be dispersed into an effective solvent to form a suspension. The suspension may be coated onto a substrate. The solvent may be evaporated, and the coating may be cured on the substrate.

In an embodiment, the nanoparticles may include carbon nanotubes having a diameter less than about 100 nanometers. In further embodiments, the polymer composite may contain the nanoparticles in an amount of from about 0.5 to about 10% by weight of the composite.

In still further embodiments, the polymer may be a copolymer of vinylidene fluoride with another monomer selected from the group consisting of hexafluoropropylene, tetrafluoroethylene, and a mixture thereof,

In some embodiments, the extrusion may include single screw or twin screw extrusion, and in certain embodiments the extrusion may include an extrusion temperature from about 150° C. to about 200° C.

Several embodiments may include adding a cross-linking agent to the suspension prior to coating. Where in some embodiments the cross-linking agent may include a bisphenol compound.

For an exemplary embodiment, the substrate may include a fusing member. In embodiments, a method coating may include flow coating.

In yet another embodiment, a fusing member may include a substrate with at least one fluoropolymer composite coating. The composite coating may include a plurality of substantially non-agglomerated carbon nanotubes in a fluoropolymer, and wherein the composite coating has a volume resistivity less than 1×10⁸ ohm-cm. In some embodiments, the fusing member may include a carbon nanotube concentration in the composite coating is about 0.5% to about 10% by weiglt of the composite. In exemplary embodiments, the floropolymer may contain more than 60% by weight of fluorine content. In further embodiments, the fluoropolymer may be a copolymer of vinylidene fluoride with another monomer selected from the group consisting of hexafluoropropylene, tetrafluoroethylene, and mixtures thereof. Still yet in other embodiments, the composite coating may be crosslinked.

### BRIEF DESCRIPTION OF THE DRAWINGS

FIG. 1 depicts a schematic of a basic twin screw extruder known to those of skill in the art.

FIG. 2 depicts a flow diagram of a method to form a carbon nanotube/fluoropolymer coating on a fuser member.

FIG. 3 depicts a transmission electron micrograph of exemplary embodiment of a CNT/Viton® composite after extrusion.

FIG. 4 depicts a transmission electron micrograph of a Viton® fuser coating with dispersed CNTs on a substrate resulting from an initial extrusion process.

### DETAILED DESCRIPTION

Before the present methods, systems and materials are described, it is to be * understood that this disclosure is not limited to the particular methodologies, systems and materials described, as these may vary It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise, in addition, the word “comprising” as used herein is intended to mean “including but not limited to.” Unless defined otherwise, all technical and scientific terms used herein have the same meanings as commonly understood by one of ordinary skill in the art,

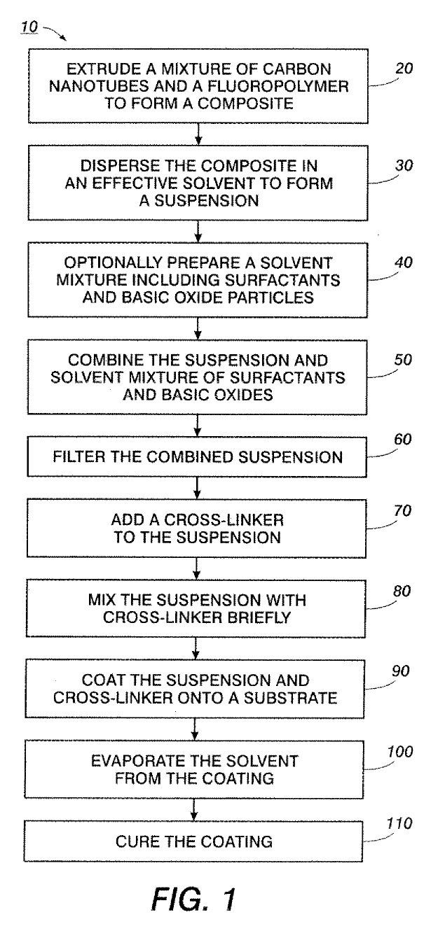

Referring to FIG. 1, an exemplary method of preparing carbon nanotube-reinforced fluoropolymer coatings 10 is presented. The method includes dispersive mixing of a mixture of carbon nanotubes (CNTs) and a fluoropolymer to form a composite 20. Dispersive mixing, as defined in text book entitled “Polymer Processing” (written by James M. McKelvey, published by John Wiley & Sons, Inc), involves the rupture of agglomerates of ultimate particles in a polymer. The fluoropolymer may include a semi-soft or molten fluoropolymer. In an embodiment, the dispersive mixing is accomplished by high shear or mechanical shear force in an extruder or a Banbury mixer. Any effective extrusion process known in the prior art may be applied for the process described herein. For instance, the extrusion may be performed using a single screw or a twin screw extruder.

An exemplary process may involve the use of a commercially prepared masterbatch of CNT/fluoropolymer material, followed by lowering the concentration of CNT by a letdown extrusion process, where the master batch is co-extruded with a neat fluoropolymer. For example, a commercially prepared masterbatch of 12% (w/w) multiwalled CNT in a fluoropolymer Viton®-A (E. I. du Pont de Nemours and Company) is available from Hyperion Catalysis International. For embodiments herein, it may be desirable to Lower the CNT concentration in the final composite extrudate. As such, a masterbatch as described, for example, may be co-extruded with a neat fluoropolymer, such as Viton®-A and Viton®-GFE The resulting letdown polymer may have a final concentration of CNTs of 1 to about 10% by weight of the polymer composite, for example, where the carbon nanotubes are substantially non-agglomerated and substantially uniformly dispersed in the composite. Alternatively, the CNTs could be added to neat fluoropolymer and extruded so that the CNTs are non-agglomerated and substantially uniformly dispersed in the composite. The phrase “non-agglomerated” as used herein is a condition in which the nanotubes or nanoparticles are substantially singly dispersed within the matrix. The phrase “substantially uniformly dispersed” as used herein, is a condition in which the concentration of nanotubes or nanoparticles is substantially the same throughout the matrix.

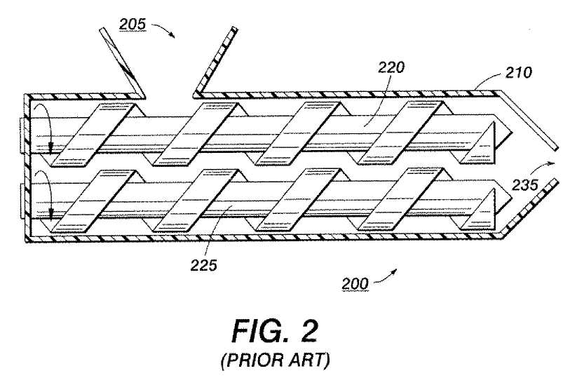

A twin screw extrusion may be used for dispersive mixing and forming the CNT/polymer composite. Alternatively single screw extrusion may be used for dispersive mixing and forming the CNT/polymer composite. Twin screw extrusion is used extensively for mixing, compounding, or reacting polymeric materials. A schematic of the basics of a twin screw extruder 200 is depicted in FIG. 2. A polymeric material, possibly with other agents may be inserted into the extruder 200 at the barrel entrance 205, so that the materials are confined in a barrel 210 of the extruder 200. The materials may be kept in a semi-solid or a molten state by external heating, for example, in the barrel 210. Two rotating screws 220, 225 are present in the barrel that mix and convey the materials in the barrel 210 of the extruder, resulting in a mixed, compounded, and/or reacted material or extrudate that is collected at the barrel exit 235. A twin screw extruder has two screws that may rotate in the same direction, or in opposite directions. The screws may be intermeshing or non-intermeshing. In addition, the configurations of the screws themselves may be varied using forward conveying elements, reverse conveying elements, kneading blocks, and other designs in order to achieve particular mixing characteristics. The operation of twin screw extruders are known to those of ordinary skill in the art.

The CNTs dispersed in the fluoropolymer are an example of a solid-solid dispersion. A dispersion is a two-phase system where one phase consists of finely divided particles/nanotubes, often in the colloidal size range, distributed throughout a bulk substance, the particles/tubes being the dispersed or internal phase, and the bulk substance the continuous phase. (Hawley's Cottenseed Chemical Dictionary 14^{th} Ed, Rev. by R. J. Lewis, Sr., John) Wiley & Sons, Inc., New York (2001) p. 415).

Carbon nanotubes (CNTs) are an allotrope of carbon. They take the form of cylindrical graphitic carbons and have novel properties that make them useful in a wide variety of applications in nanotechnology, electronics, optics and other fields of materials science. They exhibit extraordinary strength and unique electrical properties, and are efficient conductors of heat. Carbon nanofibers are similar to carbon nanotubes in dimension and they are cylindric structures, but they are not perfect cylinders, as are CNTs. Carbon nanofibers are within the scope of embodiments herein. Herein, carbon nanotubes and carbon nanofibers may be referred to collectively as carbon fibrils. Further, in the broadest sense “carbon nanotubes” and “carbon fibrils” are used interchangeably herein, and for embodiments herein the scope of the two phrases includes single walled carbon nanotubes, multi-walled carbon nanotubes, and carbon fibers.

Nanotubes are members of the fullerene structural family, which also includes buckyballs. Whereas buckyballs are spherical in shape, a nanotube is cylindrical. The diameter of a nanotube is on the order of a few nanometers, while they can be up to several millimeters in length. Embodiments herein may include carbon nanotubes having a diameter less than about 100 nanometers. There are two main types of nanotubes: single-walled nanotubes (SWNTs) and multi-walled nanotubes (MWNTs), both of which are encompassed in embodiments herein.

Referring back to FIG. 1, once the desired concentration of CNTs are dispersively mixed ore extruded into a composite, where the carbon nanotubes are non-agglomerated and substantially uniformly dispersed in the composite, the composite itself is dispersed 30 into an effective solvent to form a suspension. Effective solvents include, but are not limited to, acetone, methyl isobutyl ketone (MIBK), methyl ethyl ketone (MEK), and mixtures thereof. The suspension includes solubilized polymer with a substantially uniformly dispersed suspension of substantially non-agglomerated CNTs. The suspension has been found to be relatively stable in a substantially uniformly dispersed state for a period of greater than one hour.

The suspensions may be sonicated or homogenized to aid in dispersing the suspension. The methods of sonication, that is, using an ultrasonic bath or ultrasonic probe for agitation of solutions and suspensions is known to those of skill in the art and need not be further elaborated upon here.

A suspension is a system in which very small particles (solid, semisolid, or liquid) are more or less uniformly dispersed in a liquid or gaseous medium. If the particles are small enough to pass through filter membranes the system is a colloidal suspension. The term colloids refer to matter when one or more of its dimensions lie in the range between 1 millimicron (nanometer) and 1 micron (micrometer). (Hawley's Condensed Chemical Dictionary, 14^{th} Ed, Rev. by R. J. Lewis, Sr., John Wiley & Sons, Inc., New York (2001) pp. 286, 1062).

In embodiments herein, when the CNT/fluoropolymer composite is dispersed into an effective solvent, a suspension is formed. Embodiments of the suspension herein could be considered a colloidal suspension, since they are able to pass through filter membranes. In addition, a solid in liquid colloidal suspension can interchangeably be referred to as a colloidal dispersion. (or loosely called a solution). (Hawley's Condensed Chemical Dictionary, 14^{th} Ed, Rev. by R. J. Lewis, Sr., John Wiley & Sons, Inc., New York (2001) pp. 415, 1062).

The stability of suspensions of embodiments herein is increased compared with other methods of forming CNT/fluoropolymer suspensions. The stability of a suspension is the tendency for the particles to remain suspended in the solvent and not settle out to the bottom of the container. A major obstacle for use of CNT in prior art coatings has been their tendency for agglomeration. Carbon nanotubes are usually thought of as one atom thick layers of graphite, called graphene sheets rolled up into nanometer-sized cylinders or tubes. For embodiments herein carbon nanotubes may have a diameter less than about 100 nanometers. CNTs tend to pack into bundles or ropes, at least partially due to strong dispersion interactions between graphene sheets of respective nanotubes. The CNT bundles are not easily dispersed into individual CNTs when mixed into a solvent. The CNT bundles in a solvent settle faster than individually dispersed CNTs. Further, when a suspension of bundled CNTs with fluoropolymers is used for coating a substrate, a non-homogeneous coating is produced on the surface. The non-homogeneous coating with bundled CNTs results in a reduction of mechanical strength of the coating and a reduction in the thermal and electrical conductivity of the coating, as compared with a coating where the CNTs are substantially non-agglomerated and substantially uniformly dispersed.

While not intending to be held to a particular scientific theory it is postulated that in embodiments herein, non-agglomerated CNTs and the fluoropolymer chains undergo a bonding interaction during the high shear stress that is experienced in the extrusion process. It is further postulated that this interaction persists when the composite is dispersed into the solvent; the solvent does not displace the fluoropolymer chains from the CNTs when the suspension is formed. The bonding interaction may be a physical interaction, such as through van der Waals forces, or perhaps the extrusion shear is high enough to form stronger, more chemical-like, bonding between the CNTs and the fluoropolymer chains. This association may prevent the CNTs from agglomerating in the solvent and settling out of the solvent, and increases the stability of the suspension. The stabilization of the suspension, resulting from interactions of the CNT and the fluoropolymer formed during the extrusion, may be a form of steric stabilization.

Regardless of the type of interaction that is promoted in the high shear environment of the twin screw extruder, the stability of the CNT fluoropolymer suspensions of embodiments herein, is significantly increased over previous methods of forming the suspension. For example, direct mixing of CNTs with fluoropolymer into solvent results in suspensions with only short-term stability. Short-term stability of suspensions is also observed when CNTs are milled in fluoropolymer solution prior to forming the suspension.

Continuing to refer to FIG. 1, optionally, surfactants may be added to a second solvent, and this solvent mixture may include basic oxides, such as MgO and Ca(OH)₂ that act as dehydrofluorinating agents or acid acceptors, which aid in cross-linking the fluoropolymer 40. The optional second solvent mixture may also be sonicated.

The two mixtures may be combined 50, and filtered 60 through, for example, a filter disc with a 20 μm pore-size. Filtering 60 is utilized to remove non-colloidal solids, such as the basic oxide particles, so they are not present in the substrate coating. The suspension resulting from the mixing 50 and filtering 60 steps of embodiments herein also exhibits increased stability, as described above.

A solution of bonding agent, curing agent, or cross-linker may be added to the filtered suspension 70. Exemplary cross-linkers are bisphenol compounds. An exemplary bisphenol cross-linker may include Viton® Curative No. 50 (VC-50) available from E. I. du Pont de Nemours, Inc. VC-50 is soluble in a solvent suspension of the CNT and fluoropolymer and is readily available at the reactive sites for cross-linking. Curative VC-50 contains Bisphenol-AF as a cross-linker and diphenylbenzylphosphonium chloride as an accelerator. Bisphenol-AF is also known as 4,4′-(hexafluoroisopropylidene)diphenol. The suspension containing the cross-linker is mixed briefly 80, as the cross-linking in solution occurs rapidly.

The suspensions with the cross-linkers are coated onto a suitable substrate 90. Suitable substrates may include fusing members, such as but not limited to belts, plates, and cylindrical drums. Gap coating can be used to coat a flat substrate, such as a belt or plate, whereas flow coating can be used to coat a cylindrical substrate, such as a drum or fuser roll. Various means of coating substrates are familiar to those skilled in the art and need not be elaborated upon herein.

After coating, the solvent may be at least partially evaporated 100. In an exemplary embodiment, the solvent was allowed to evaporate for about two hours or more at room temperature. Other evaporation times and temperatures are within the scope of embodiments herein.

Following evaporation the coating may be cured 110. An exemplary curing process is a step-wise cure. For example, the coated substrate may be placed in a convection oven at about 149° C. for about 2 hours; the temperature may be increased to about 177° C. and further curing may take place for about 2 hours; the temperature may be increased to about 204° C. and the coating is further cured at that temperature for about 2 hours; lastly, the oven temperature may be increased to about 232° C. and the coating may be cured for another 6 hours. Other curing schedules are possible. Curing schedules known now or hereinafter to those skilled in the art are within the scope of embodiments herein.

The thickness of the composite coating after curing may range from about 5 μm to about 100 μm. in other embodiments, a composite coating thickness of about 20 μm to about 50 μm is produced.

Dispersive mixing with a twin screw extruder is an embodiment herein; however other forms of high shear extrusion familiar now or hereafter to those skilled in the art are encompassed in embodiments herein.

An exemplary extrusion temperature ranges from about 100° C. to about 250° C. Alternatively, an extrusion temperature range may be from about 100° C. to about 250° C., or from about 150° C. to about 200° C.

An exemplary rotor speed for extrusion is from about 10 revolutions per minute (rpm) to about 200 rpm.

The extrusion of embodiments herein may use a CNT/fluoropolymer mixture of about 0.1% to about 40% (w/w) of CNT in a fluoropolymer. Other embodiments use about 1% to about 20% (w/w) of CNT in fluoropolymer.

Fluoropolymers that may be used in embodiments herein may have a monomeric repeat unit that is selected from the group consisting of vinylidene fluoride, hexafluoropropylene, tetrafluoroethylene, and mixtures thereof. The fluoropolymers may include linear or branched polymers, and cross-linked fluoroelastomers. Examples of fluoropolymer include a poly(vinylidene fluoride), or a copolymer of vinylidene fluoride with another monomer selected from the group consisting of hexafluoropropylene, tetrafluoroethyelene, and a mixture thereof.

Embodiments of fluoropolymers herein include the Viton® fluoropolymers from E. I. du Pont de Nemours, Inc. Viton® fluoropolymers include for example: Viton®-A, copolymers of hexafluoropropylene (HEP) and vinylidene fluoride (VDF or VF2), Viton®-B, terpolymers of tetrafluoroethylene (TEE), vinylidene fluoride (VDF) and hexafluoropropylene (HFEP); and Viton®-GF, tetrapolymers composed of TFE, VE2, HFP, and small amounts of a cure site monomer.

Effective solvents of embodiments herein include, but are not limited to, methyl isobutyl ketone and methyl ethyl ketone. Other solvents that form stable suspensions, as described herein, are within the scope of the embodiments herein and include those solvents known now or hereafter by one of ordinary skill in the art.

CNT/fluoropolymer composite coated fusing members are embodiments herein. The fusing member of an embodiment may include a substrate, and at least one fluoropolymer composite coating. The composite coating includes a plurality of substantially uniformly dispersed individual carbon nanotubes in a fluoropolymer. The composite coating may have a volume resistivity less than 1×10 ⁸ ohm-cm. In other embodiments the composite coating may have a volume resistivity less than 1×10 ⁶ ohm-cm.

The fusing member of an embodiment may include a metallic substrate, and may further include substrates of aluminum, anodized aluminum, steel, nickel, copper, and mixtures thereof. Other substrate fusing member materials known now or hereafter to one of ordinary skill in the art are within the scope of the embodiments herein. The fusing member substrate may include a hollow cylinder, a belt, or a sheet.

The fusing member composite coating may contain about 0.1% to about 40% (w/w) of CNT in a fluoropolymer. Other embodiments use about 1% to about 20% (w/w) of CNT in fltuoropolymer. Still other embodiments use about 1% to about 10% (w/w).

The fusing member composite coating may include having a monomeric repeat unit that is selected from the group consisting of vinylidene fluoride, hexafluoropropylene, tetrafluoroethylene, and mixtures thereof The fluoropolymers may include vinylidene fluoride with another monomer selected from the group consisting of vinylidene fluoride, hexafluoropropylene, tetrafluoroethyelene, and a mixture thereof. The fluoropolymers in the composite coating may include linear or branched polymers, and cross-linked fluoroelastomers, and may be cross-linked with bisphenol compounds, such as but not limited to, 4,4′-(hexafluorolsopropylidene) diphenol in the presence of a diphenylbenzylphosphoniunm salt. The fluoropolymers may also include brominated peroxide cure sites, or other cure sites known to those skilled in the art, that can be use for free radical curing of the fluoropolymers. The fluoropolymers of embodiments herein may contain more than 60% by weight of fluorine content.

Because of a large surface area to volume ratio, nanoparticles may have a tendency to clump together or agglomerate, and as such may not be amenable to processing into nanoparticle/polymer composites. A nanoparticle is a microscopic particle with at least one dimension measured in nanometers.

Embodiments of methods herein include extruding a mixture of nanoparticles and at least one polymer to form a composite. The extrusion process produces nanoparticles in a substantially non-agglomerated and substantially uniformly dispersed condition in the composite. The nanoparticle/polymer composite is dispersed into an effective solvent to form a substantially stable suspension. The solvent may be acetone, MEK of MIBK or any solvent that will cause substantial dissolution of the polymer chains with subsequent suspension of the nanoparticle in the solvent, so that the nanoparticles remain substantially non-agglomerated and substantially uniformly dispersed. Effective solvents include those now or hereafter known to one of skill in the art for the appropriate polymer system.

The suspension of nanoparticles and polymer may be coated onto a substrate. After coating the solvent may be evaporated. The coating may be cured on the substrate. Curing may take place by techniques such as ultraviolet light curing or other radiation curing, or may be affected by adding a cross-linking agent to the dispersed suspension prior to coating, with or without applied heat. Embodiments of the method include applying the nanoparticle/polymer coating onto a fusing member.

Nanoparticles of embodiments herein may include for example, but are not limited to, carbon nanotubes, carbon fiber, carbon black, metal powders, oxide powders, and others that are known now or hereafter to one of ordinary skill in the art.

Polymers that are embodiments herein include for example, but are not limited to fluoropolymers, fluoroelastomers, polyurethanes, polysiloxanes, silicones, and others that are known now or hereafter to one of ordinary skill in the art.

### EXAMPLES

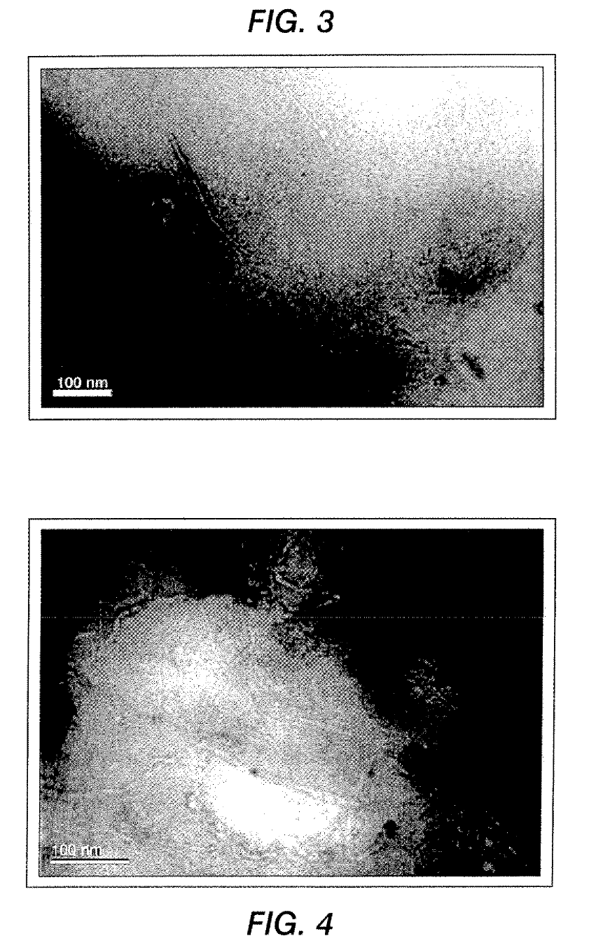

Fluoropolymer composite-1, 2, and 3, were prepared by dispersive mixing of Viton CGF and a CNT masterbatch (containing 12% (w/w) of multi-walled CNT in Viton GF, commercially purchased from Hyerion Catalysis International) as described in following table. The two polymers were heated to about 170° C. and extruded using a twin screw extruder at a rotor speed of 20 revolutions per minute (rpm) for 20 minutes. The resulting letdown polymer contained 3, 5, and 8 weight percent of carbon nanotubes, respectively. A transmission electron micrograph (TEM) of the coating, is presented in FIG. 3 and shows an even distribution of the CNTs in the letdown CNT/Viton® composite.

| | Composite-1 | Composite-2 | Composite-3 |
|---|---|---|---|
| | (3% CNT) | (5% CNT) | (8% CNT) |
| Masterbatch | 12.5 g | 20.83 g | 33.33 g |
| (12% CNT in Viton GF) | | | |
| Viton GF | 37.5 g | 29.17 g | 16.67 g |
| Total weight | 50 g | 50 g | 50 g |

To form a fuser coating, 41 g of the letdown composite (Composite-1, 2, and 3) was mixed with 200 g of methyl isobutyl ketone for 18 hours. The resulted mixture was sonicated for 15 minutes to form a coating solution. Prior to coating, a designated amount (for example, but not limited to, about 0.5 parts per hundred (pph)) of a curing agent mixture including magnesium oxide, calcium hydroxide, and VC-50 (Viton® Curative No. 50 available from E. I. du Pont de Nemours, Inc.) pre-mixed in methyl isobutyl ketone was added to the coating solution The resulted dispersions (suspensions) were then coated onto a suitable fuser roll substrate. The coating was allowed to evaporate most of the solvent, followed by curing at about 170° C. for 2 hours and additional 6 hours at about 200° C. The thickness of the composite coating was about 25 microns after curing. To examine the dispersion quality and the electrical resistivity of the composite coating, a set of coatings were cast on a flat substrate using a gap coater, followed by curing in a similar manner. FIG. 4 presents a TEM image of the coating with 5 wt % of CNT that shows that the CNTs were substantially non-agglomerated and substantially uniformly dispersed within the coating.

Electrical surface resistivity was measured on a sample coated on a silicon wafer using a 4-point probe, and compared to that of a Viton®-GF cross-linked coating of the same composition as is currently used to coat fuser rolls. The Viton®-GF coating displayed high surface resistivity (>10¹¹ Ohm/sq) indicating that the coating acts as an insulator, while the coating containing 5% reinforcement of the CNTs was conductive (surface resistivity=5.28×10³ Ohms/sq).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for forming a stable suspension, comprising:
dispersive mixing a semi-soft or molten fluoropolymer and a plurality of carbon fibrils by mechanical shear force to form a polymer composite; and
dispersing the composite into an effective solvent to form a stable suspension.

2. The method of claim 1, wherein the dispersive mixing comprises extrusion.

3. The method of claim 2, wherein the extrusion comprises operating an extruder at a rotor speed from about 10 revolutions per minute to about 200 rpm.

4. The method of claim 1, wherein the fluoropolymer comprises vinylidene fluoride with another monomer selected from the group consisting of vinylidene fluoride, hexafluoropropylene, tetrafluoroethyelene, and mixtures thereof.

5. The method of claim 1, wherein the carbon fibrils comprise carbon nanotubes having a diameter less than about 100 nanometers.

6. The method of claim 1, wherein the polymer composite contains carbon fibrils in an amount of from about 0.3 to about 30% by weight of the composite.

7. The method of claim 1, wherein the polymer composite contains carbon fibrils in an amount of from about 0.5 to about 10% by weight of the composite.

8. The method of claim 1, wherein the effective solvent is selected from the group consisting of acetone, methyl isobutyl ketone, methyl ethyl ketone, and mixtures thereof.

9. A method, comprising:
dispersive mixing of nanoparticles and at least one polymer comprising a monomeric repeat unit of vinylidene fluoride by extrusion to form a composite, wherein the nanoparticles are substantially non-agglomerated and substantially uniformly dispersed in the composite;
dispersing the composite into an effective solvent to form a suspension;
coating the suspension onto a substrate;
evaporating the solvent; and
curing the coating on the substrate.

10. The method of claim 9, wherein the nanoparticles comprise carbon nanotubes having a diameter less than about 100 nanometers.

11. The method of claim 9, wherein the polymer composite contains the nanoparticles in an amount of from about 0.5 to about 10% by weight of the composite.

12. The method of claim 9, wherein the polymer is a copolymer of vinylidene fluoride with another monomer selected from the group consisting of hexafluoropropylene, tetrafluoroethyelene, and a mixture thereof.

13. The method of claim 9, wherein the extrusion comprises single screw or twin screw extrusion.

14. The method of claim 9 wherein the extrusion comprises operating an extruder at an extrusion temperature from about 150° C. to about 200° C.

15. The method of claim 9, further comprising adding a cross-linking agent to the suspension prior to coating.

16. The method of claim 15, wherein the cross-linking agent comprises a bisphenol compound.

17. The method of claim 9, wherein the substrate comprises a fusing member.

18. The method of claim 9, wherein the coating comprises flow coating.

19. A fusing member, comprising.
a substrate; and
at least one fluoropolymer composite coating, wherein the composite coating comprises a plurality of substantially non-agglomerated carbon nanotubes in a fluoropolymer, and wherein the composite coating h a volume resistivity less than 1×10⁸ ohm-cm.

20. The fusing member of claim 19, wherein a carbon nanotube concentration in the composite coating is about 0.5% to about 10% by weight of the composite.

21. The fusing member of claim 19, wherein the fluoropolynier contains more than 60% by weight of fluorine content.

22. The fusing member of claim 19, wherein the fluoropolymer is a copolymer of vinylidene fluoride with another monomer selected from the group consisting of hexafluoropropylene, tetrafluoroethyelene, and mixtures thereof.

23. The fusing member of claim 19, wherein the composite coating is crosslinked.
